(19) United States
(12) Patent Application Publication
(10) Pub. No.: US 2013/0289906 A1
(43) Pub. Date: Oct. 31, 2013

(54) CIRCUIT FOR DISPLAYING ENERGY CONSUMPTION

(71) Applicants: YA-JUN PAN, Shenzhen City (CN); TING GE, Shenzhen City (CN)

(72) Inventors: YA-JUN PAN, Shenzhen City (CN); TING GE, Shenzhen City (CN)

(21) Appl. No.: 13/650,169

(22) Filed: Oct. 12, 2012

(30) Foreign Application Priority Data
Apr. 25, 2012 (CN) 201210123700.0

(51) Int. Cl. G06F 19/00

(52) U.S. Cl. 702/61

(57) ABSTRACT

A circuit is used for displaying the amount of electrical energy consumed by an electronic device. The circuit includes an analog to digital (A/D) converting circuit, a microprocessor connected to the A/D converting circuit, and a display connected to a microprocessor for displaying the energy consumed by the electronic device.

### BACKGROUND

1. Technical Field

The present disclosure relates to a circuit for displaying energy consumption.

2. Description of Related Art

Computers are used more and more, but energy conscious users may want to but cannot know energy consumption of the computers every month. This is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a circuit for displaying energy consumption, wherein the circuit includes first to fifth analog to digital (A/D) converting circuits, a microprocessor, and a display.

FIG. 2 is a circuit diagram of the first A/D converting circuit of FIG. 1.

FIG. 3 is a circuit diagram of the microprocessor.

FIG. 4 is a circuit diagram of the display.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

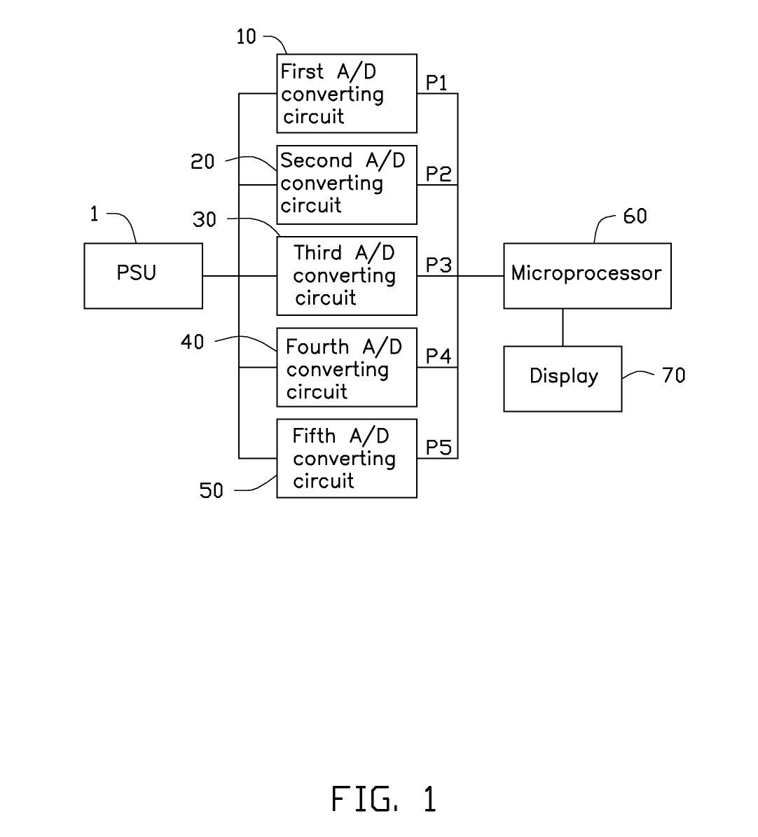

Referring to FIG. 1, a circuit for displaying energy consumption of a computer is shown. An embodiment of the circuit includes a first analog to digital (A/D) converting circuit 10, a second A/D converting circuit 20, a third A/D converting circuit 30, a fourth A/D converting circuit 40, a fifth A/D converting circuit 50, a microprocessor 60, and a display 70. The first to fifth A/D converting circuits 10-50 are respectively connected to power outputs of a power supply unit (PSU) 1 of the computer.

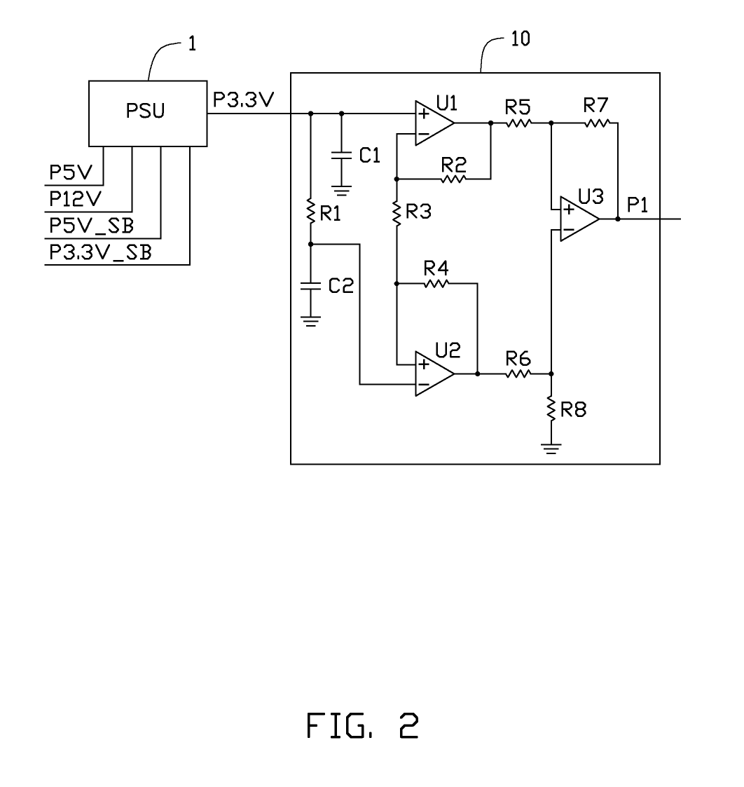

Referring to FIG. 2, in the embodiment, the PSU 1 of the computer includes five power outputs P3.3V, P3.3V_SB, P5V, P5V_SB, and P12V. Each of the first to fifth A/D converting circuits 10-50 has the same structure, and is connected to one of the power outputs of the PSU 1. FIG. 2 only shows the structure of the first A/D converting circuit 10. The first A/D converting circuit 10 includes three amplifiers U1, U2, and U3. The power output P3.3V of the PSU 1 is connected to a non-inverting terminal of the amplifier U1. The power output P3.3V is further connected to an inverting terminal of the amplifier U2 through a resistor R1. The non-inverting terminal of the amplifier U1 is further grounded through a capacitor C1. A node between the inverting terminal of the amplifier U2 and the resistor R1 is further grounded through a capacitor C2. An inverting terminal of the amplifier U1 is connected to an output terminal of the amplifier U1 through a resistor R2. A node between the inverting terminal of the amplifier U1 and the resistor R2 is connected to a non-inverting terminal of the amplifier U2 through a resistor R3. A node between the non-inverting terminal of the amplifier U2 and the resistor R3 is connected to an output terminal of the amplifier U2 through a resistor R4.

The output terminal of the amplifier U1 is further connected to a non-inverting terminal of the amplifier U3 through a resistor R5. The output terminal of the amplifier U2 is further connected to an inverting terminal of the amplifier U3 through a resistor R6. A node between the non-inverting terminal of the amplifier U3 and the resistor R5 is connected to an output terminal of the amplifier U3 through a resistor R7. A node between the inverting terminal of the amplifier U3 and the resistor R6 is grounded through a resistor R8. An output terminal of the amplifier U3 functions as an output terminal P1 of the first A/D converting circuit 10, and is connected to the microprocessor 60.

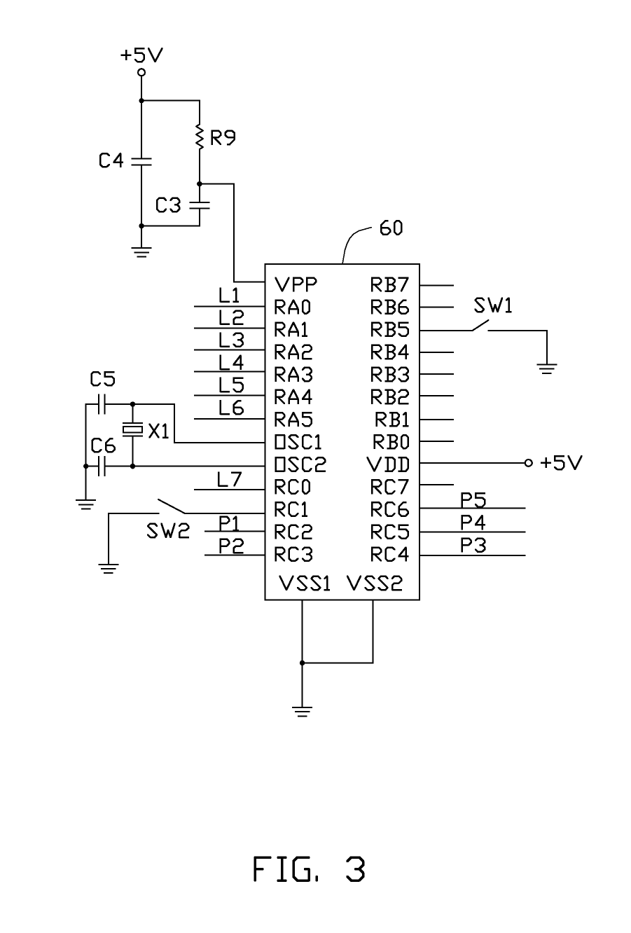

Referring to FIG. 3, a power pin VPP of the microprocessor 60 is connected to a power supply +5V through a resistor R9. The power pin VPP of the microprocessor 60 is further grounded through a capacitor C3. The power supply +5V is further grounded through a capacitor C4. Another power pin VDD of the microprocessor 60 is connected to the power supply +5V. A first group of input and output (I/O) pins RA0-RA5 of the microprocessor 60 are connected to the display 70. Seven pins RB0-RB4, RB6, and RB7 of a second group of I/O pins of the microprocessor 60 are idle. A pin RB5 of the second group of I/O pins is grounded through a switch SW1. A pin RC0 of a third group of I/O pins of the microprocessor 60 is connected to the display 70. A pin RC1 of the third group of I/O pins is grounded through a switch SW2. Pins RC2-RC6 of the third group of pins are respectively connected to the output terminals P1-P5 of the first to fifth A/D converting
circuits 10-50. A pin RC7 of the third group of I/O pins is idle. Clock pins OSC1 and OSC2 of the microprocessor 60 are respectively connected to two terminals of a quartz oscillator X1. The two terminals of the quartz oscillator X1 are respectively grounded through capacitors C5 and C6. Ground pins VSS1 and VSS2 of the microprocessor 60 are grounded.

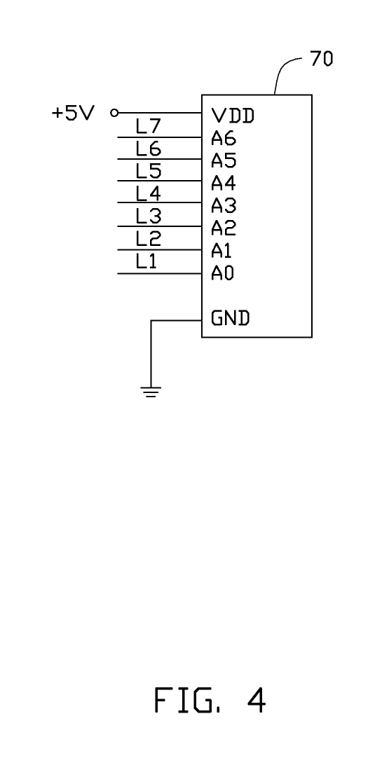

Referring to FIG. 4, a power pin VDD of the display 70 is connected to the power supply +5V. Data pins A0-A6 of the display 70 are respectively connected to the I/O pins RA0-RA5 and the pin RC0 of the microprocessor 60.

The first A/D converting circuit 10 converts a voltage between two terminals of the resistor R1 to a digital signal, and transmits the digital signal to the microprocessor 60. The microprocessor 60 receives the digital signal and determines a current flowing from the power output P3.3V of the PSU 1 according to a resistance of the resistor R1. Based on the current value and the voltage value, the microprocessor 60 determines a power of the power output P3.3V of the PSU 1.

In the same manner as the first A/D converting circuit 10, the microprocessor 60, utilizing the second to fifth A/D converting circuits 20-50, determines a power of each of the power output P3.3V_SB, P5V, P5V_SB, and P12V of the PSU 1. The microprocessor 60 further obtains a sum of the powers of the power outputs P3V, P3.3V_SB, P5V, P5V_SB, and P12V. A product of the sum of the powers and a working time of the PSU 1 is equal to the total energy consumed by the PSU 1. The product of the sum of the powers and the working time of the PSU 1 can be displayed by the display 70.

In the embodiment, the switch SW2 controls the microprocessor 60 to operate or not. When the switch SW2 is pressed, the microprocessor 60 operates. At this time, the microprocessor 60 begins to measure the working time of the PSU 1. The switch SW1 is used to reset the microprocessor 60.

The foregoing description of the exemplary embodiments of the disclosure has been presented only for the purposes of illustration and description and is not intended to be exhaustive or to limit the disclosure to the precise forms disclosed. Many modifications and variations are possible in light of the above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A circuit for displaying energy consumption of an electronic device, the circuit comprising:
at least one analog to digital (A/D) converting circuit, wherein each of the at least one A/D converting circuit is connected to a corresponding power output of a power supply unit (PSU) of the electronic device, each A/D converting circuit comprises a voltage-sensing resistor, the A/D converting circuit converts a voltage between two terminals of the voltage-sensing resistor to a digital signal;
a microprocessor connected to each A/D converting circuit, wherein the microprocessor receives the digital signal from each A/D converting circuit, and obtains a current flowing from the power output of the PSU according to the digital signal and a resistance of the voltage-sensing resistor, the microprocessor further obtains a power output of the PSU according to the current and the digital signal, and obtains the energy consumption of the electronic device according to the power output of the PSU and a working time of the electronic device; and
a display connected to a microprocessor, for displaying the energy consumption of the electronic device.

2. The circuit of claim 1, wherein each A/D converting circuit comprises first to third amplifiers, the power output of the PSU is connected to a non-inverting terminal of the first amplifier, the power output of the PSU is further connected to an inverting terminal of the second amplifier through the voltage-sensing resistor, the non-inverting terminal of the first amplifier is further grounded through a first capacitor, a node between the inverting terminal of the second amplifier and the voltage-sensing resistor is grounded through a second capacitor, an inverting terminal of the first amplifier is connected to an output terminal of the first amplifier through a first resistor, a node between the inverting terminal of the first amplifier and the first resistor is connected to a non-inverting terminal of the second amplifier through a second resistor, a node between the non-inverting terminal of the second amplifier and the second resistor is connected to an output terminal of the second amplifier through a third resistor, the output terminal of the first amplifier is further connected to a non-inverting terminal of the third amplifier through a fourth resistor, the output terminal of the second amplifier is further connected to an inverting terminal of the third amplifier through a fifth resistor, a node between the non-inverting terminal of the third amplifier and the fourth resistor is connected to an output terminal of the third amplifier through a sixth resistor, a node between the inverting terminal of the third amplifier and the fifth resistor is grounded through a seventh resistor, the output terminal of the third amplifier functions as an output terminal of the A/D converting circuit and is connected to the microprocessor.

3. The circuit of claim 2, wherein the at least one A/D converting circuits comprises first to fifth A/D converting circuits, the first to fifth A/D converting circuits are respectively connected to first to fifth power outputs of the PSU, the first to fifth A/D converting circuits are connected to the microprocessor; the display displays a product of a sum of a power of each of the first to fifth power outputs of the PSU and a working time of the PSU.

4. The circuit of claim 3, wherein a first power pin of the microprocessor is connected to a power supply through an eighth resistor, the power pin of the microprocessor is further grounded through a third capacitor, the power supply is further grounded through a fourth capacitor, a second power pin of the microprocessor is connected to the power supply, a first group of input and output (I/O) pins of the microprocessor are connected to the display, first to fifth, seventh and eighth pins of a second group of I/O pins of the microprocessor are idle, a sixth pin of the second group of I/O pins is grounded through a first switch, a first pin of a third group of I/O pins of the microprocessor is connected to the display, a second pin of the third group of I/O pins is grounded through a second switch, third to seventh pins of the third group of I/O pins are respectively connected to the output terminals of the first to fifth A/D converting circuits, an eighth pin of the third group of I/O pins is idle, two clock pins of the microprocessor are respectively connected to two terminals of a quartz oscillator, the two terminals of the quartz oscillator are further respectively grounded through fifth and sixth capacitors, a ground pin of the microprocessor is grounded.

5. The circuit of claim 4, wherein a power pin of the display is connected to the power supply, a ground pin of the display is grounded, first to seventh data pins of the display are respectively connected to the first group of I/O pins and the first pin of the third group of I/O pins of the microprocessor.
